(19) United States
(12) Patent Application Publication
(10) Pub. No.: US 2009/0075018 A1
(43) Pub. Date: Mar. 19, 2009

(54) COLORED POLYAMIDE FIBER AND PROCESS FOR PRODUCING THE SAME

(75) Inventors: Tetsuya Ashida, Okayama (JP); Shinichi Yoshimoto, Okayama (JP); Hisao Yoneda, Okayama (JP); Yusuke Takahashi, Tokyo (JP); Kenjiro Tomita, Tokyo (JP); Minoru Hotta, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Kuraray Co., Ltd, Kurashiki-city, Okayama (JP); Dainichiseika Color & Chemicals Mfg. Co. Ltd., Chuo-ku, Tokyo (JP)

(21) Appl. No.: 11/908,063

(22) PCT Filed: Mar. 1, 2006
(86) PCT No.: PCT/JP2006/303876

§ 371 Date: Mar. 7, 2008

(30) Foreign Application Priority Data
Mar. 9, 2005 (JP) 2005-065214

(51) Int. Cl. C08K 5/20; B32B 33/00; B32B 5/00

(52) U.S. Cl. 428/91; 524/186; 428/401; 428/372; 428/221

(57) ABSTRACT

A colored polyamide fiber composed of a polyamide resin, a pigment, a coupling agent and a compound represented by the following formula I:

R′—CO—NH—R—NH—CO—R″ (I)

wherein R is an alkylene group having 1 to 4 carbon atoms, and R′ and R″ are each independently an aliphatic hydrocarbon group having 9 to 18 carbon atoms. The colored polyamide fibers are produced without causing bending and fiber break during the melt spinning even when the raw composition contains the pigment in a high concentration. Since the pigment is uniformly dispersed throughout the colored polyamide fibers, the coloration is deep and the strength is high. The colored polyamide fibers are suitable for the production of artificial leathers.

### TECHNICAL FIELD

The present invention relates to colored polyamide fibers (spun-dyed polyamide fibers) excellent in fiber properties which are produced from a colored polyamide composition which can be stably melt-spun without causing bending and fiber break even when containing a pigment in a high concentration. The present invention further relates to a production method of the colored polyamide fibers and an artificial leather which is made of a fiber-entangled body constituted by the colored polyamide fibers.

### BACKGROUND ART

Generally, super fine fibers are inferior to fibers with ordinary fineness in the dyeability. Therefore, a large amount of dye is required to dye a suede material made of super fine fibers in a deep color, thereby reducing the quality such as a fastness to light and a color fastness and increasing the production costs. To eliminate these problems, a method of adding a pigment to the raw material for super fine fibers in advance, i.e. so-called spun dyeing has been generally employed.

However, in order to allow polyamide super fine fibers with a fineness of 0.9 dtex or low, particularly 0.1 dtex or low to be pigmented well, a large amount of a pigment should be added. If adding in a large amount, the pigment interacts with the amide linkages and terminal groups of polyamide, to give a molten product where the pigment concentration is locally high and increase the melt viscosity. This necessarily deteriorates the spinnability due to fiber break during spinning, clogging of nozzle and clogging of filter and reduces the fiber properties.

To improve the spinnability and fiber properties of spun-dyed fibers, there have been proposed a method in which an aliphatic carboxamide is incorporated into a spun-dyed polyamide (Patent Document 1), a method in which a fine powder of an acid-modified polyolefin and acid-modified polyester is dispersed in a polyamide resin (Patent Document 2) and a method in which a carbon black having a dibutyl phthalate absorption of 30 to 600 cm³/100 g is incorporated (Patent Document 3). To improve the spinnability and fiber properties of spun-dyed, super fine fibers, proposed is a method in which a polyamide having a melt flow rate of 3 to 7 g/10 min in the presence of a pigment is used (Patent Document 4).

Although silent about the spinning, a method in which a carbon black and a dispersant are added during the production of polyamide (Patent Document 5) and a method in which an aliphatic carboxyamide is incorporated into a colored polyamide (Patent Document 6) have been proposed to improve the properties and stability of a polyamide resin containing a pigment.

[Patent Document 1] JP 3-220313A

[Patent Document 2] JP 8-157713A

[Patent Document 3] JP 2002-146624A

[Patent Document 4] JP 2001-279532A

[Patent Document 5] JP 54-37997B

[Patent Document 6] JP 61-55146A

In the production of super fine fibers having a fineness of 0.9 dtex or low, particularly 0.1 dtex or low from a master batch containing the proposed dispersant or additive, the bending during melt spinning (bending of the flow of molten polymer discharged from a spinning nozzle) and the fiber break cannot be avoided to fail to produce fibers which withstand the practical use, when the content of colorant is increased to 3% or more for deep coloration or carbon black with a fine particle size is used as the pigment.

### DISCLOSURE OF THE INVENTION

The present invention has been made to solve the above problems in the prior art. An object of the present invention is to provide colored polyamide fibers excellent in fiber properties which are produced from a colored polyamide composition which can be stably melt-spun without causing the bending and fiber break even when containing a pigment in a high concentration. Another object of the present invention is to provide a production method of the colored polyamide fibers.

As a result of extensive research, the inventors have found that a polyamide resin composition containing a pigment in combination with a specific compound and coupling agent has a good spinnability and is made into colored polyamide fibers having good properties without causing the bending and fiber break even when the concentration of the pigment is high. The present invention is based on this finding.

Namely, the present invention relates to a colored polyamide fiber composed of a polyamide resin, a pigment, a coupling agent and a compound represented by the following formula I:

R′—CO—NH—R—NH—CO—R″ (I)

wherein R is an alkylene group having 1 to 4 carbon atoms, and R′ and R″ are each independently an aliphatic hydrocarbon group having 9 to 18 carbon atoms.

The present invention farther relates to an artificial leather composed of a fiber-entangled body of the colored polyamide fibers and a nap-finished artificial leather which is produced by raising and dyeing the artificial leather.

The present invention still further relates to a method of producing colored polyamide fibers, which includes a step of spinning a colored polyamide composition containing a polyamide resin, a pigment, a coupling agent and a compound represented by the following formula I:

R′—CO—NH—R—NH—CO—R″ (I)

wherein R is an alkylene group having 1 to 4 carbon atoms, and R′ and R″ are each independently an aliphatic hydrocarbon group having 9 to 18 carbon atoms.

### BEST MODE FOR CARRYING OUT THE INVENTION

The present invention will be described below in detail.

The colored polyamide fiber of the invention at least contains a polyamide resin, a pigment, a compound of the formula I and a coupling agent.

The polyamide resin may be selected from nylon 6, nylon 66, nylon 12, nylon 10, nylon 610, and copolyamides thereof. When coloring the polyamide resin with a pigment-containing master batch, the polyamide resin for the master batch and the polyamide resin to be colored are preferably similar to each other in their melting points and chemical structures in view of a dispersion stability of pigment. The number average molecular weight of the polyamide resin to be colored is preferably from 11,000 to 20,000. Within the above range, the fiber properties are good and the stretchability during spinning and stretching are good to prevent the fiber break and fluffing. Since the fiber break and fluffing are more remarkable in super fine fibers and super fine fiber-forming fibers, it is preferred to regulate the number average molecular weight within the above range.

Examples of the pigments usable in the invention include organic pigments such as azo pigments, phthalocyanine pigments, perylene pigments and anthraquinone pigments and inorganic pigments such as carbon black, red oxide, titanium oxide and ultramarine blue. As the most expedient method for the industrial production of super fine fibers, there have been employed a method in which super fine fiber-forming fibers are converted to super fine fibers by the removal of one component or the splitting. In such a method of converting to super fine fibers, since an organic solvent is generally used, a part of the organic pigment unfavorably dissolves in the organic solvent. Therefore, the inorganic pigment is preferably used, and particularly, carbon black having a small particle size is most suitable in view of preventing the fiber break during spinning and obtaining stable fiber properties when super fine fibers having a fineness of 0.01 dtex or low are to be produced.

The type of carbon black is not limited and any of channel black, furnace black and thermal black may be used in the invention. The average primary particle size of carbon black is preferably from 8 to 120 nm and more preferably from 15 to 30 nm. Within the above range, the secondary agglomeration of carbon black particles is prevented, to increase the tenacity of the colored polyamide fibers to be produced. In addition, the polyamide fibers are preferably colored in deep color.

The blending amount of the pigment in a master batch is preferably from 10 to 35 parts by mass per 100 parts by mass of the polyamide resin in view of production costs and stable production of master batch, and more preferably from 15 to 30 parts by mass.

The content of the pigment in fibers depends upon the fineness of fibers to be produced, and is preferably from 1 to 30 parts by mass per 100 parts by mass of the polyamide resin in the colored polyamide fibers. Within the above range, the coloration is sufficiently deep and the colored polyamide fibers acquire strength sufficient for withstanding practical use even when the fibers are super fine fibers. For the colored polyamide fibers having an average fineness of 0.9 dtex or low, the blending amount of pigment is more preferably from 3 to 15 parts by mass, still more preferably from 5 to 12 parts by mass, and particularly preferably from 6 to 11 parts by mass each based on 100 parts by mass of the polyamide resin, because good spinnability, good fiber properties and deep coloration are achieved at the same time.

In addition to the pigment, a compound represented by the following formula I:

R′—CO—NH—R—NH—CO—R″ (I)

wherein R is an alkylene group having 1 to 4 carbon atoms, and R′ and R″ are each independently an aliphatic hydrocarbon group having 9 to 18 carbon atoms, is blended to the polyamide resin.

Examples of the compound of formula I include methylene bisstearamide, ethylene bisstearamide, methylene bislaurylamide, ethylene bislaurylamide, methylene bismyristylamide, ethylene bismyristylamide, methylene bispalmitamide, ethylene bispalmitamide, methylene bisoleamide, ethylene bisoleamide, methylene bislinolamide, and ethylene bislinolamide, with methylene bisstearamide and ethylene bisstearamide being particularly preferred in view of the fiber properties and spinnability.

The blending amount of the compound of the formula I in a master batch is preferably from 0.2 to 20 parts by mass per 100 parts by mass of the polyamide resin. The final content in the colored polyamide fiber is preferably from 0.001 to 3 parts by mass and more preferably from 0.1 to 2.5 parts by mass per 100 parts by mass of the polyamide resin.

The dispersion stability of the pigment may be improved by the addition of a coupling agent. Any of known coupling agents such as silane coupling agent, titanate coupling agent and aluminum coupling agent may be used in the present invention.

Examples of the silane coupling agent include vinyltrichlorosilane, vinyltrimethoxysilane, vinyltriethoxysilane, vinyltris(β-methoxyethoxy)silane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, N-β-(aminoethyl)-γ-aminopropylmethyldimethoxysilane, N-β-(aminoethyl)-γ-aminopropyltrimethoxysilane, N-β-(aminoethyl)-γ-aminopropyltriethoxysilane, γ-aminopropyltrimethoxysilane, γ-aminopropyltriethoxysilane, N-phenyl-γ-aminopropyltrimethoxysilane, γ-chloropropyltrimethoxysilane, γ-mercaptopropyltrimethoxysilane, and γ-ureidopropyltriethoxysilane.

Examples of the titanate coupling agent include isopropyltrioctanoyl titanate, isopropyltriisostearoyl titanate, isopropyldimethacrylisostearoyl titanate, isopropylisostearoyldiacryl titanate, isopropyltri(N-aminoethyl-aminoethyl) titanate, isopropyltri(dioctyl phosphate) titanate, isopropyltris(dioctyl pyrophosphate) titanate, isopropyltridodecylbenzenesulfonyl titanate, isopropyltricumylphenyl titanate, tetraisopropylbis(dioctyl phosphite) titanate, tetraoctylbis(ditridecyl phosphite) titanate, tetra(2,2-diallyloxymethyl-1-butyl)bis(ditridecyl) phosphite titanate, bis(dioctyl pyrophosphate)oxyacetate titanate, and bis(diocyl pyrophosphate)ethylene titanate. Of the above, preferred are isopropyltris(dioctyl pyrophosphate) titanate and isopropyltridodecylbenzenesulfonyl titanate.

The above coupling agents may be used alone or in combination of two or more. Most preferred in view of its effect is the titanate coupling agent.

The blending amount of the coupling agent in a master batch is preferably from 0.3 to 5 parts by mass per 100 parts by mass of the polyamide resin. Within the above range, the spinnability is good and the reduction of the spinnability due to the increase of melt viscosity does not occur. The blending amount is more preferably from 0.5 to 3 parts by mass. The final content in the colored polyamide fibers is preferably from 0.05 to 2 parts by mass and more preferably from 0.1 to 1 part by mass each based on 100 parts by mass of the polyamide resin.

The mechanism of the synergistic effect by the combined use of the compound of the formula I and the coupling agent has not yet been elucidated. It is assumed at present that the compound of the formula I improves the flowability of molten polyamide, and simultaneously, inhibits the interaction between the activated sites of pigment and the polyamide molecules by the mutual dissolution with the polyamide, and that the coupling agent reacts with the activated sites of pigment to block the activated sites.

With such a synergistic effect, the pigment is dispersed uniformly. As a result, a high density of coloration is obtained while keeping a high spinnability, and the resultant colored polyamide fibers acquire a higher strength as compared with known super fine fibers containing a pigment in the same blending amount.

The colored polyamide fibers may be optionally added with, in addition to the pigment, etc., a modifier such as an antiflaming agent, an antistatic agent, a dyeing aid, a lubricant, a delustering agent, an antioxidant, a ultraviolet absorber, a thinning agent, a thickening agent and a functional additive such as an antibacterial agent, a deodorant and a fungicide.

The colored polyamide fiber of the invention is preferably a super fine fiber having an average fineness of 0.9 dtex or low because a fabric which combines a good hand and good properties is obtainable. The average fineness is more preferably from 0.0001 to 0.9 dtex in view of combining good fiber properties, hand and color development, still more preferably from 0.001 to 0.1 dtex in view of obtaining colored polyamide fibers having good fiber properties and a deep coloration and an artificial leather having a good hand, and particularly preferably from 0.001 to 0.01 dtex.

The production method of the colored polyamide fibers of the invention will be described below.

The colored polyamide fibers are produced by a known method such as a method in which super fine fiber-forming fibers are converted to super fine fibers and a method in which super fine fibers are directly spun. The super fine fiber-forming fiber is a composite fiber composed of two or more kinds of polymer components, which has a sea-island, radial, multi-layered, or other types of fiber cross section. The super fine fiber-forming fiber produced by a composite spinning is converted to colored polyamide super fine fibers by the splitting or removal of at least one constituting component by extraction. Alternatively, polyamide super fine fibers are obtained from a mix-spun, sea-island super fine fiber-forming fiber by removing the sea component by extraction. The production of super fine fiber-forming fibers and their conversion to super fine fibers are conducted by known methods. If necessary, the super fine fiber-forming fiber may be drawn by a known method, for example, may be drawn by 1 to 5 times in a water bath at 20 to 100° C.

When the blending amount of pigment is increased, the strength of polyamide super fine fibers which are produced by removing at least one constituting component from a composite-spun fiber or a mix-spun fiber tends particularly to be largely reduced to deteriorate the spinnability. The present invention is particularly effective in the production of polyamide super fine fibers from a super fine fiber-forming fiber such as a composite-spun fiber and a mix-spun fiber.

The component which forms the super fine fiber after the conversion treatment (super fine fiber-forming component), for example, the island component of sea-island fiber, is made of a colored polyamide composition at least containing the polyamide resin, the pigment, the compound of the formula I and the coupling agent, each being described above. The component to be removed by extraction, for example, the sea component of sea-island fiber, may be a thermoplastic resin which is mix-spinnable or composite-spinnable together with the super fine fiber-forming component. Preferred examples thereof include resins such as polyethylene, polypropylene, polybutylene, polystyrene, and polyvinyl chloride which are soluble in a solvent such as hot toluene, xylene and halogenated hydrocarbon and water-soluble resins such as polyvinyl alcohol-based resins.

The composite-spun fiber or mix-spun fiber having the super fine fiber-forming component, which contains at least the polyamide resin, the pigment, the compound of the formula I and the coupling agent, is produced, for example, by a method of spinning a colored polyamide composition which is obtained by blending the polyamide resin pellets, the pigment, the compound of the formula I, and the coupling agent in the above blending ratios or a method of spinning a mixture of a polyamide master batch and polyamide pellets in which the polyamide master batch contains the pigment in a high concentration and is added with predetermined amounts of the compound of the formula I and the coupling agent. Taking the production costs, easiness of changing the fiber composition and workability into consideration collectively, the method of spinning a mixture of the master batch and polyamide resin pellets is more preferred. The colored polyamide composition and the mixture of the master batch and polyamide resin pellets are spun by a method under conditions, each being known in the fiber-making art. Since a person skilled in the art can easily select or determine the spinning method and spinning conditions, the detail thereof is omitted here.

The master batch and polyamide resin pellets are melt-kneaded, for example, by a method in which the master batch pellets and resin pellets are premixed in a batch mixer such as Nauta mixer and double corn blender and then kneaded in a melt extruder or a method in which the master batch pellets and polyamide resin pellets are separately and continuously fed into a melt extruder from respective metering devices in a predetermined proportion and then kneaded therein. When mixing in the batch mixer prior to melting, it is preferred to take a proper measure for reducing the uneven dispersion due to classification, for example, supplying the mixed pellets into the melt kneader from the position just above it.

Next, the production of artificial leather will be described below, in which a fiber-entangled body is formed from staples or filaments of sea-island fibers (super fine fiber-forming fibers) having an island component made of the super fine fiber-forming component which contains at least the polyamide resin, the pigment, the compound of the formula I, and the coupling agent and a sea component made of polyethylene, and the fiber-entangled body is made into the artificial leather.

A staple web is formed by a known method, for example, by carding sea-island fibers and then making the carded fibers into a random web or crosslap web through a webber. A filament web is formed by a known method, for example, efficiently produced by a spun bond method directly combined with the melt spinning. The obtained webs are superposed in predetermined weight and thickness. The sea-island fibers may be used alone or, if necessary, in combination with another type of fiber such as non-sea-island fibers with an ordinary fineness (for example, single-component fibers having a single fiber fineness of 0.5 to 2 dtex).

Then, the fiber web is needle-punched by a known method, to obtain a fiber-entangled body. After pressing the fiber-entangled body under heating so as to have a desired thickness, an elastic polymer is impregnated into the fiber-entangled body. Known resins conventionally used in the production of artificial leather substrates are suitably used as the elastic polymer to be impregnated. Examples thereof include polyurethane resins, polyvinyl chloride resins, polyacrylic acid resins, polyamino acid resins, silicone resins, copolymers thereof, and mixtures thereof, with the polyurethane resins being preferred because a uniform spongy structure is obtained by the coagulation and the mechanical properties are good. The elastic polymer may be blended with a colorant, a coagulation modifier, a stabilizer, an antioxidant, etc. The elastic polymer is impregnated into the fiber-entangled body in the form of a solution in an organic solvent or an aqueous emulsion.

After the impregnating liquid is impregnated into the inside of the fiber-entangled body, the elastic polymer is coagulated by the treatment with a non-solvent to the elastic polymer or the gelation under heating. After optionally washing and drying, a fibrous substrate is obtained. The content of the elastic polymer is preferably from 10 to 60 parts by mass (solid basis) per 100 parts by mass of the fibrous substrate, because a hand like natural leathers is obtained. The content of the elastic polymer varies according to the final use. For example, the content is preferably from 10 to 40 parts by mass in view obtaining a soft hand and increasing the fiber density on the surface when a suede-finished artificial leather is intended. The content is preferably from 30 to 60 parts by mass in view of making the surface flat and smooth when a grain-finished artificial leather is intended.

After coagulating the impregnated elastic polymer, the obtained fibrous substrate is treated with a treating liquid which is a non-solvent to the polyamide resin (island component) in the sea-island fibers and elastic polymer but a solvent or decomposer to the polyethylene (sea component), for example, a hydrocarbon solvent such as toluene and xylene. With this treatment, the polyethylene is removed from the sea-island fibers by extraction, to obtain the artificial leather composed of the fiber-entangled body, which is made of the colored polyamide super fine fibers, and the elastic polymer. After napping the artificial leather by a known method, the napped artificial leather is preferably subjected to the surface treatment such as dyeing and brushing, to obtain a nap-finished artificial leather. As compared with nap-finished artificial leathers colored by a general dyeing method, the obtained nap-finished artificial leather has a surface appearance with a sufficiently deep coloration even when the blending amount of dye is small. The obtained nap-finished artificial leather is excellent in the mechanical properties and various fastness properties without causing granular mass (fuse-bonded fibers) due to defective spinning which often occurs when the pigment is incorporated into super fine fibers by a known technique. The artificial leather can be made into a grain finished artificial leather by forming a coating layer on the surface by a known method. To utilize the effect of the spun-dyed super fine fibers of the invention fully, the grain-finished artificial leather is preferably produced by a method in which the coating layer is formed on the surface of the artificial leather or napped artificial leather by gravure-coating the resin which is usable in the preparation of the impregnating liquid mentioned above and then the surface of the resultant coating layer is embossed. Alternatively, the grain-finished artificial leather is produced by a method of laminating a film of the resin on the artificial leather and then embossing the surface or a method of embossing the surface of the artificial leather without forming the surface coating layer.

As described above, the present invention provides colored polyamide fibers excellent in the fiber properties and stability in the spinning step without causing bending and fiber break during the melt spinning even when containing a colorant in a high concentration. Since the pigment is dispersed uniformly throughout the polyamide fibers, colored super fine fibers containing the pigment in a high concentration are stably produced by the production method of the invention. The colored polyamide fibers find wide application such as wipers, filters and artificial leathers. The artificial leather made of the colored super fine fibers with a small fineness, particularly the nap-finished artificial leather having napped super fine fibers on the surface such as a suede-finished or nubuck-finished artificial leather has a colored appearance with a high density.

### EXAMPLES

The present invention will be described in more detail with reference to the examples. However, it should be noted that the scope of the present invention is not limited to the following examples. Unless otherwise noted, the “part(s)” and “%” in the examples are based on mass.

The properties were measured by the following methods.

### (1) Average Fineness of Super Fine Fibers

Non-drawn bundles of sea-island fibers (sea component: polyethylene) were drawn by 2.0 times in a hot water bath at 70° C. and then fixed on a frame. The bundles of fibers were immersed in toluene at 80° C. to extract polyethylene from the fibers and dried to obtain bundles of super fine fibers. The bundles of super fine fibers were observed under a scanning electron microscope to calculate the average fineness from the following equation:

Fiber fineness=D×(R/2)²×10⁶

wherein R is an average diameter (cm) of the super fine fibers in the bundle and D is a specific gravity of the super fine fiber.

R was determined as follows: a cross-sectional photograph of the bundles of super fine fibers was taken under a scanning electron microscope; ten bundles of super fine fibers were selected randomly; 20 super fine fibers were randomly and evenly selected from the cross section of each bundle of super fine fibers; the diameter of each of the selected super fine fibers was measured; and the measured diameters were averaged to obtain R.

### (2) Degree of Fiber Breaks

The number of fiber breaks occurred during spinning 1 t of fibers was counted. The degree of fiber breaks is expressed by the number of occurrence of fiber breaks per 100 kg of spun fibers.

### (3) Strength

Measured according to JIS 1013 by pulling a non-drawn bundle of sea-island fibers using an autograph in a chuck interval of 10 cm at a head speed of 20 cm/min.

### (4) Elongation

Measured according to JIS 1013 by pulling a non-drawn bundle of sea-island fibers using an autograph in a chuck interval of 10 cm at a head speed of 20 cm/min.

### Example 1

A mixture of 80 parts of chips of nylon 6 having a number average molecular weight of 13,000, 20 parts of carbon black having a primary particle diameter of 20 nm, 2 parts of ethylene bisstearamide and 0.5 part of isopropyl triisostearoyl titanate was melt-kneaded in a melt extruder at 280° C. The obtained strands were water-cooled and cut to obtain a master batch for spun-dyeing polyamide.

In a chip blender, 25 parts of the master batch for spun-dyeing polyamide, 25 parts of chips of nylon 6 having a number average molecular weight of 13,000 and 50 parts of low density polyethylene chips were mixed.

The resultant mixture was spun at 280° C. from a ordinary melt spinning machine having 24 spinning holes, to obtain non-drawn sea-island fibers having a fineness of 10.0 dtex and composed of a nylon 6 island component and a polyethylene sea component. The degree of fiber breaks during the spinning was about 0.15 per 100 kg. The properties of the non-drawn sea-island fiber are shown in Table 2.

The obtained non-drawn sea-island fibers were drawn by 2.0 times in a hot water bath at 70° C., to obtain drawn sea-island fibers having a fineness of 5 dtex.

The drawn sea-island fibers were crimped and cut into staples having a fiber length of 51 mm. The staples were carded, superposed and then needle-punched to prepare a fiber-entangled body having a mass per weight of 500 g/m². The fiber-entangled body was impregnated with a 15% polyether polyurethane solution in dimethylformamide and then the polyether polyurethane was wet-coagulated by an aqueous solution of dimethylformamide. After washing with water, the polyethylene sea component was removed by extraction with 90° C. toluene to obtain an artificial leather having a mass per weight of 450 g/m² and a thickness of 0.9 mm. After buffing one surface of the obtained artificial leather with a sand paper to raise the naps, the artificial leather was dyed with 6% owf of a metal-containing complex dye, Irgalan Black 2RL (Ciba-Geigy AG), crumpled and then brushed, to obtain a nap-finished artificial leather. The obtained nap-finished artificial leather had a uniform surface and colored in deep black. In addition, the peeling strength was high and the hand was soft. No defect (granular mass) attributable to defective spinning was observed on the suede surface.

### Example 2

Non-drawn sea-island fibers having a fineness of 15 dtex were produced in the same manner as in Example 1 except for using a mixture which was prepared by mixing 30 parts of the master batch for spun-dyeing polyamide prepared in Example 1, 30 parts of chips of nylon 6 having a number average molecular weight of 13,000 and 40 parts of low density polyethylene chips in a chip blender. The degree of fiber breaks during the spinning was about 0.1 per 100 kg. The properties of the non-drawn sea-island fiber are shown in Table 2.

Then, a nap-finished artificial leather was produced in the same manner as in Example 1. No defect (granular mass) attributable to defective spinning was observed on the surface.

### Example 3

Non-drawn sea-island fibers having a fineness of 15.0 dtex were produced in the same manner as in Example 1 except for using a mixture which was prepared by mixing 21 parts of the master batch for spun-dyeing polyamide prepared in Example 1, 39 parts of chips of nylon 6 having a number average molecular weight of 13,000 and 40 parts of low density polyethylene chips in a chip blender. The degree of fiber breaks during the spinning was about 0.1 per 100 kg. The properties of the non-drawn sea-island fiber are shown in Table 2.

Then, a nap-finished artificial leather was produced in the same manner as in Example 1. No defect (granular mass) attributable to defective spinning was observed on the surface.

### Example 4

Non-drawn sea-island fibers having a fineness of 15.0 dtex were produced in the same manner as in Example 1 except for using a mixture which was prepared by mixing 36 parts of the master batch for spun-dyeing polyamide prepared in Example 1, 24 parts of chips of nylon 6 having a number average molecular weight of 13,000 and 40 parts of low density polyethylene chips in a chip blender. The degree of fiber breaks during the spinning was about 0.2 per 100 kg. The properties of the non-drawn sea-island fiber are shown in Table 2.

Then, a nap-finished artificial leather was produced in the same manner as in Example 1. No defect (granular mass) attributable to defective spinning was observed on the surface.

### Example 5

A mixture of 80 parts of chips of nylon 6 having a number average molecular weight of 13,000, 20 parts of carbon black having a primary particle diameter of 20 nm, 2 parts of methylene bisstearamide and 0.5 part of isopropyl triisostearoyl titanate was melt-kneaded in a melt extruder in the same manner as in Example 1. The obtained strands were water-cooled and cut to obtain a master batch for spun-dyeing polyamide.

In a chip blender, 30 parts of the master batch, 30 parts of chips of nylon 6 having a number average molecular weight of 13,000 and 40 parts of low density polyethylene chips were mixed. In the same manner as in Example 1 except for using the obtained mixture, non-drawn sea-island fibers having a fineness of 15.2 dtex were obtained. The degree of fiber breaks during the spinning was about 0.1 per 100 kg. The properties of the non-drawn sea-island fiber are shown in Table 2.

Then, a nap-finished artificial leather was produced in the same manner as in Example 1. No defect (granular mass) attributable to defective spinning was observed on the surface.

### Example 6

A mixture of 80 parts of chips of nylon 6 having a number average molecular weight of 13,000, 20 parts of carbon black having a primary particle diameter of 20 nm, 2 parts of ethylene bisstearamide and 0.5 part of isopropyl tri(N-aminoethyl) titanate was melt-kneaded in a melt extruder in the same manner as in Example 1. The obtained strands were water-cooled and cut to obtain a master batch for spun-dyeing polyamide.

In a chip blender, 80 parts of the master batch, 30 parts of chips of nylon 6 having a number average molecular weight of 13,000 and 40 parts of low density polyethylene chips were mixed. In the same manner as in Example 1 except for using the obtained mixture, non-drawn sea-island fibers having a fineness of 14.8 dtex were obtained. The degree of fiber breaks during the spinning was about 0.25 per 100 kg. The properties of the non-drawn sea-island fiber are shown in Table 2.

Then, a nap-finished artificial leather was produced in the same manner as in Example 1. No defect (granular mass) attributable to defective spinning was observed on the surface.

### Example 7

A mixture of 80 parts of chips of nylon 6 having a number average molecular weight of 13,000, 20 parts of carbon black having a primary particle diameter of 25 nm, 2 parts of ethylene bisstearamide and 0.5 part of isopropyl triisostearoyl titanate was melt-kneaded in a melt extruder in the same manner as in Example 1. The obtained strands were water-cooled and cut to obtain a master batch for spun-dyeing polyamide.

In a chip blender, 30 parts of the master batch, 30 parts of chips of nylon 6 having a number average molecular weight of 13,000 and 40 parts of low density polyethylene chips were mixed. In the same manner as in Example 1 except for using the obtained mixture, non-drawn sea-island fibers having a fineness of 15.1 dtex were obtained. The degree of fiber breaks during the spinning was about 0.2 per 100 kg. The properties of the non-drawn sea-island fiber are shown in Table 2.

Then, a nap-finished artificial leather was produced in the same manner as in Example 1. No defect (granular mass) attributable to defective spinning was observed on the surface.

### Example 8

A mixture of 80 parts of chips of nylon 6 having a number average molecular weight of 13,000, 20 parts of carbon black having a primary particle diameter of 20 nm, 2 parts of ethylene bisstearamide and 0.5 part of vinyltriethoxysilane was melt-kneaded in a melt extruder in the same manner as in Example 1. The obtained strands were water-cooled and cut to obtain a master batch for spun-dyeing polyamide.

In a chip blender, 30 parts of the master batch, 30 parts of chips of nylon 6 having a number average molecular weight of 13,000 and 40 parts of low density polyethylene chips were mixed. In the same manner as in Example 1 except for using the obtained mixture, non-drawn sea-island fibers having a fineness of 15.1 dtex were obtained. The degree of fiber breaks during the spinning was about 0.2 per 100 kg. The properties of the non-drawn sea-island fiber are shown in Table 2.

Then, a nap-finished artificial leather was produced in the same manner as in Example 1. No defect (granular mass) attributable to defective spinning was observed on the surface.

### Comparative Examples 1 to 8

In the same manner as in Example 1 except for changing the bis(aliphatic carboxamide) and the coupling agent as shown in Table 1, non-drawn sea-island fibers having a fineness of 10.0 dtex were produced. The degree of fiber breaks during the spinning and the properties of the non-drawn sea-island fibers are shown in Table 2.

Then, a nap-finished artificial leather was produced in the same manner as in Example 1. Although the nap-finished artificial leather was colored in deep black and the hand was soft, many defects (granular mass) attributable to defective spinning were scattered on the surface.

TABLE 1

| | Carbon black | | | |
|---|---|---|---|---|
| | | Primary particle | Bis(aliphatic | |
| Fineness | | diameter | carboxamide) | Coupling agent |
| (dtex) | (parts by mass)* | (μm) | (parts by mass)* | (parts by mass)* |

Examples

| | | | | | |
|---|---|---|---|---|---|
| 1 | 0.001 | 10.96 | 20 | ethylene | isopropyl |
| | | | | bisstearamide | triisostearoyl |
| | | | | 1.10 | titanate |
| | | | | | 0.27 |
| 2 | 0.01 | 10.95 | 20 | ethylene | isopropyl |
| | | | | bisstearamide | triisostearoyl |
| | | | | 1.10 | titanate |
| | | | | | 0.28 |
| 3 | 0.01 | 7.40 | 20 | ethylene | isopropyl |
| | | | | bisstearamide | triisostearoyl |
| | | | | 0.74 | titanate |
| | | | | | 0.18 |
| 4 | 0.01 | 13.47 | 20 | ethylene | isopropyl |
| | | | | bisstearamide | triisostearoyl |
| | | | | 1.34 | titanate |
| | | | | | 0.35 |
| 5 | 0.01 | 10.95 | 20 | methylene | isopropyl |
| | | | | bisstearamide | triisostearoyl |
| | | | | 1.10 | titanate |
| | | | | | 0.28 |
| 6 | 0.01 | 10.95 | 20 | ethylene | isopropyl tri(N- |
| | | | | bisstearamide | aminoethyl) |
| | | | | 1.10 | titanate |
| | | | | | 0.28 |
| 7 | 0.01 | 10.95 | 25 | ethylene | isopropyl |
| | | | | bisstearamide | triisostearoyl |
| | | | | 1.10 | titanate |
| | | | | | 0.28 |
| 8 | 0.01 | 10.95 | 20 | ethylene | vinyltriethoxy- |
| | | | | bisstearamide | silane |
| | | | | 1.10 | 0.28 |

Comparative Examples

| | | | | | |
|---|---|---|---|---|---|
| 1 | 0.001 | 10.96 | 20 | — | — |
| 2 | 0.001 | 10.96 | 20 | ethylene | — |
| | | | | bisstearamide | |
| | | | | 1.10 | |
| 3 | 0.01 | 10.96 | 20 | — | isopropyl |
| | | | | | triisostearoyl |
| | | | | | titanate |
| | | | | | 0.27 |

(parts by mass)* parts by mass per 100 parts by mass of polyamide resin in super fine fiber.

TABLE 2

| | | | | |
|---|---|---|---|---|
| Degree of | | | | |
| fiber breaks | Fineness | Strength | Elongation | Defects on |
| (/100 kg) | (dtex) | (g/dtex) | (%) | surface |

Examples

| | | | | | |
|---|---|---|---|---|---|
| 1 | 0.15 | 10.0 | 0.79 | 180 | none |
| 2 | 0.1 | 15.0 | 1.05 | 190 | none |
| 3 | 0.1 | 15.0 | 1.20 | 195 | none |
| 4 | 0.2 | 15.0 | 0.84 | 180 | none |
| 5 | 0.1 | 15.2 | 1.15 | 200 | none |
| 6 | 0.25 | 14.8 | 0.75 | 140 | none |
| 7 | 0.2 | 15.1 | 0.80 | 180 | none |
| 8 | 0.2 | 15.1 | 0.85 | 160 | none |

Comparative Examples

| | | | | | |
|---|---|---|---|---|---|
| 1 | frequent | 10.0 | 0.81 | 167 | many |
| 2 | 0.4 | 10.0 | 0.79 | 175 | many |
| 3 | 0.6 | 10.0 | 0.74 | 157 | many |

### INDUSTRIAL APPLICABILITY

Since a remarkable effect can be achieved particularly on the super fine fibers having a small fineness, the present invention is widely applied to the production of nap-finished artificial leathers such as nubuck- and suede-finished artificial leathers which are required to have an elegant appearance with a deep coloration.

1. A colored polyamide fiber comprising a polyamide resin, a pigment, a coupling agent and a compound represented by formula I:
R′—CO—NH—R—NH—CO—R″ (I)
wherein R is an alkylene group having 1 to 4 carbon atoms, and R′ and R″ are each independently an aliphatic hydrocarbon group having 9 to 18 carbon atoms.

2. The colored polyamide fiber according to claim 1, having an average fineness of 0.9 dtex or low.

3. The colored polyamide fiber according to claim 1, wherein the pigment is contained in an amount of from 1 to 30 parts by mass per 100 parts by mass of the polyamide resin.

4. The colored polyamide fiber according to claim 1, wherein the pigment is carbon black having an average primary particle diameter of from 8 to 120 nm.

5. The colored polyamide fiber according to claim 1, wherein the compound of the formula I is ethylene bisstearamide or methylene bisstearamide.

6. The colored polyamide fiber according to claim 1, wherein the coupling agent is a titanate coupling agent.

7. An artificial leather comprising a fiber-entangled body which is constituted from the colored polyamide fibers as defined in claim 1.

8. A nap-finished artificial leather produced by napping and dyeing the artificial leather as defined in claim 7.

9. A method of producing colored polyamide fibers comprising a step of spinning a colored polyamide composition which comprises a polyamide resin, a pigment, a coupling agent and a compound represented by formula I:
R′—CO—NH—R—NH—CO—R″ (I)
wherein R is an alkylene group having 1 to 4 carbon atoms, and R′ and R″ are each independently an aliphatic hydrocarbon group having 9 to 18 carbon atoms.

10. The method according to claim 9, which comprises a step of forming super fine fiber-forming fibers comprising said colored polyamide composition and a step of converting the super fine fiber-forming fibers into super fine fibers having an average fineness of 0.9 dtex or lower.
